(19) United States
(12) Patent Application Publication
(10) Pub. No.: US 2022/0007401 A1
(43) Pub. Date: Jan. 6, 2022

(54) WIRELESS NODE AND RESOURCE CONTROL METHOD

(71) Applicant: NTT DOCOMO, INC., Tokyo (JP)

(72) Inventor: Hiroki Harada, Tokyo (JP)

(73) Assignee: NTT DOCOMO, INC., Tokyo (JP)

(21) Appl. No.: 17/293,550

(22) PCT Filed: Aug. 23, 2019
(86) PCT No.: PCT/JP2019/033173

§ 371 Date: May 13, 2021

(30) Foreign Application Priority Data
Nov. 15, 2018 (JP) 2018-214633

(51) Int. Cl. H04W 72/12; H04W 28/20; H04W 28/12; H04W 88/08

(52) U.S. Cl. CPC H04W 72/1278; H04W 88/08; H04W 28/12; H04W 28/20

(57) ABSTRACT

A wireless node (10) receives first information on availability of a resource of at least one of a wireless backhaul link and a wireless access link. The wireless node (10) controls, when receiving second information on a configuration of the resource, the availability of the resource based on the second information.

### TECHNICAL FIELD

The present disclosure relates to a wireless node and to a resource control method.

### BACKGROUND ART

Long Term Evolution (LTE) has been specified for achieving a higher data rate, lower latency, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

For future wireless communication systems (e.g., 5G), a technique of Integrated Access and Backhaul (IAB) that unifies an access link and a backhaul link is considered (Non-Patent Literature (hereinafter referred to as “NPL”) 1). In IAB, a wireless node like an IAB node forms a wireless access link with a User Equipment (UE), and also forms a wireless backhaul link with another IAB node and/or a wireless base station.

### CITATION LIST

### Non-Patent Literature

NPL 1
3GPP TR 38.874 V0.6.0, “3rd Generation Partnership Project; Technical Specification Group Radio Access Network; Study on Integrated Access and Backhaul; (Release 15),” November 2018
NPL 2
3GPP TSG RAN Meeting #78 RP-172290 “Study on Integrated Access and Backhaul for NR,” December 2017
NPL 3
3GPP TS 38.213 V15.3.0 (2018-09)

### SUMMARY OF INVENTION

### Technical Problem

However, no comprehensive study has been conducted for resource configurations between wireless nodes, and between the wireless node and the user equipment, so that a further study is required.

One object of the present disclosure is to appropriately perform the resource configurations between the wireless nodes, and between the wireless node and the user equipment.

### Solution to Problem

A wireless node according to one aspect of the present disclosure includes: a reception section that receives first information on availability of a resource of at least one of a wireless backhaul link and a wireless access link; and a control section that, when the reception section receives second information on a configuration of the resource, controls the availability of the resource based on the second information.

### Advantageous Effects of Invention

According to the present disclosure, it is possible to appropriately perform the resource configurations between the wireless nodes, and between the wireless node and the user equipment.

### BRIEF DESCRIPTION OF DRAWINGS

FIG. 1 illustrates a configuration example of a wireless communication system according to one embodiment of the present disclosure;

FIG. 2 illustrates a configuration example of IAB nodes according to one aspect of the present disclosure;

FIG. 3 illustrates cases of Time Division Multiplexing (TDM) supported by the IAB nodes according to one aspect of the present disclosure;

FIG. 4 illustrates a first example of transmission/reception timings for the IAB nodes according to one aspect of the present disclosure;

FIG. 5 illustrates one example of transmissions of a configuration for a Mobile Termination (MT) and a configuration for a Distributed Unit (DU) according to one aspect of the present disclosure;

FIG. 6 illustrates a second example of the transmission/reception timings for the IAB nodes according to one aspect of the present disclosure;

FIG. 7 illustrates a third example of the transmission/reception timings for the IAB nodes according to one aspect of the present disclosure;

FIG. 8 illustrates one example of Slot Format Indication (SFI) according to one aspect of the present disclosure; and

FIG. 9 illustrates an example of a hardware configuration of the IAB node and a user equipment according to one aspect of the present disclosure.

### DESCRIPTION OF EMBODIMENTS

Hereinafter, an embodiment according to one aspect of the present disclosure will be described with reference to the accompanying drawings.

<Wireless Communication System>

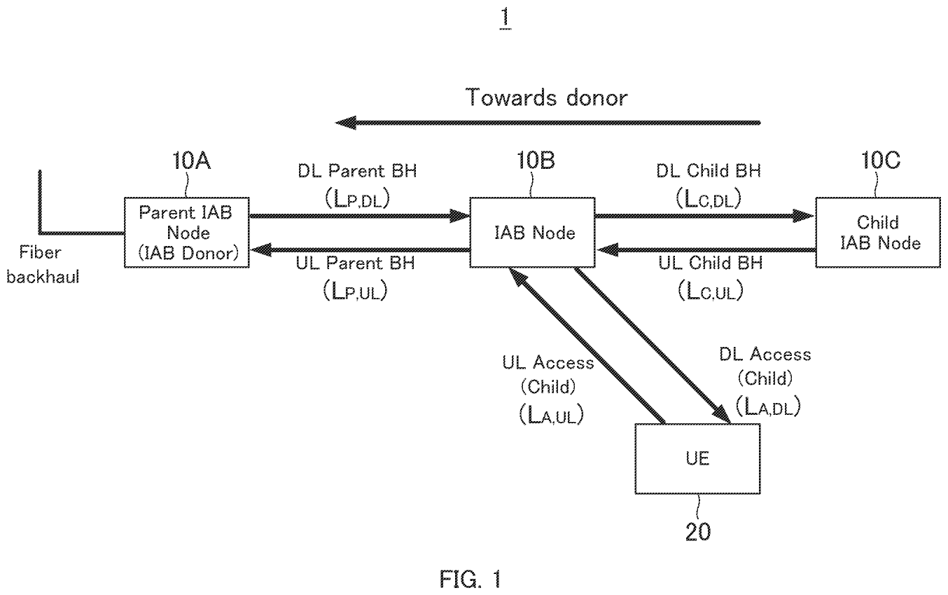

FIG. 1 illustrates a configuration example of a wireless communication system in one embodiment of the present disclosure.

Wireless communication system 1 includes a plurality of IAB nodes 10A to 10C as one example of wireless nodes, and UE 20 as one example of a user equipment. Hereinafter, like in “IAB nodes 10,” only the common numeral of the reference signs may be used to describe IAB nodes 10A to 10C without distinguishing them from one another.

IAB nodes 10A to 10C are interconnected to one another by wireless communication. IAB node 10B is connected to IAB node 10A in FIG. 1. IAB node 10C is connected to IAB node 10B. Hereinafter, IAB node 10A located upstream (that is, in the direction nearer an IAB donor) as seen from IAB node 10B is called parent IAB node 10A, and IAB node 10C located downstream (that is, in the direction away from the IAB donor) as seen from IAB node 10B is called child IAB node 10C.

The term “parent IAB node 10A” denotes that IAB node 10A is a parent IAB node with respect to IAB node 10B, and the term “child IAB node 10C” denotes that IAB node 10C is a child IAB node with respect to IAB node 10B. In other words, IAB node 10B corresponds to a child IAB node with respect to “parent IAB node 10A,” and corresponds to a parent IAB node with respect to “child IAB node 10C.”

Each of IAB nodes 10A to 10C forms a cell, which is an area in which the IAB node is able to communicate wirelessly. That is, IAB nodes 10 have a function as a base station. UE 20 in the cell is able to wirelessly connect to IAB node 10 forming the cell.

IAB node 10A may also be connected to a Core Network (CN) through a Fiber Backhaul (BH). In this case, IAB node 10A may also be called “IAB donor.” In addition, although FIG. 1 illustrates three IAB nodes 10 and one UE 20, any number of IAB nodes 10 and any number of UEs 20 may be included in wireless communication system 1. There may also be two or more parent IAB nodes with respect to one IAB node 10 and two or more child IAB nodes with respect to one IAB node 10.

Note that, “L” with its subscripts shown in FIG. 1 denote the following:
“L_{P,DL}” denotes a Downlink (DL) from parent IAB node 10A to IAB node 10B;
“L_{P,UL}” denotes a Uplink (UL) from IAB node 10B to parent IAB node 10A;
“L_{C,DL}” denotes the DL from IAB node 10B to child IAB node 10C;
“L_{C,UL}” denotes the UL from child IAB node 10C to IAB node 10B;
“L_{A,DL}” denotes the DL from IAB node 10B to UE 20; and
“L_{A,UL}” denotes the UL from UE 20 to IAB node 10B.

<IAB Node>

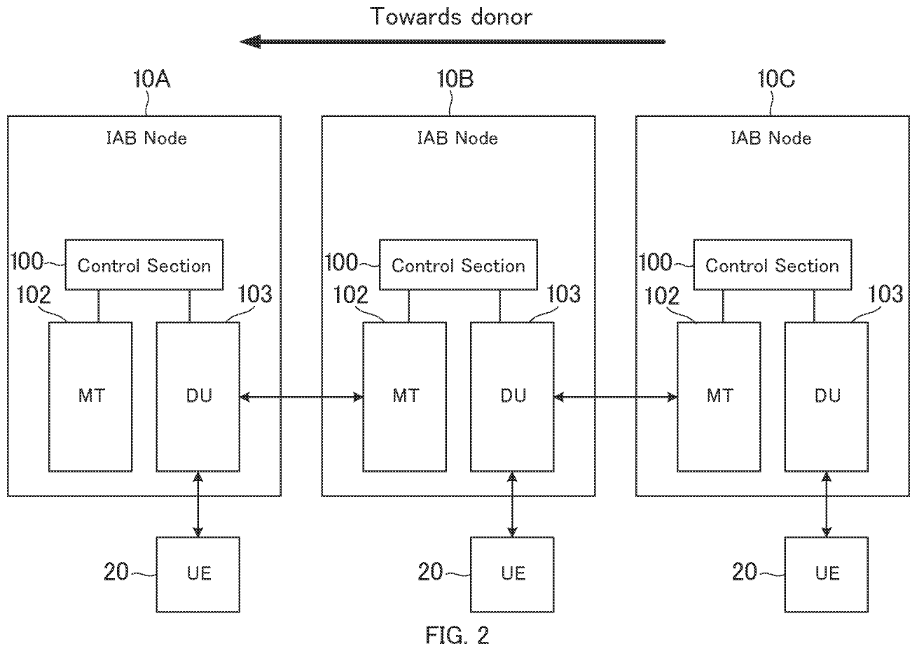

FIG. 2 illustrates a configuration example of each of IAB nodes 10. As illustrated in FIG. 2, each of IAB nodes 10 includes control section 100, Mobile Termination (MT) 102, and Distributed Unit (DU) 103. MT 102 and DU 103 may be functional blocks. Hereinafter, a function of MT 102 may be expressed as MT without the reference sign, and a function of DU 103 may be expressed as DU without the reference sign. DU 103 may have functions corresponding to those of the base station or an extension station. One example of MT 102 may have functions corresponding to those of the user equipment.

IAB node 10B is connected to upstream IAB node (or IAB donor) 10A by MT 102. That is, MT 102 of IAB node 10B treats connection to parent IAB node 10A.

IAB node 10B is connected to UE 20 and to the MT of downstream IAB node 10C by DU 103. That is, DU 103 of IAB node 10B treats connection to UE 20 and to child IAB node 10C. The connection to UE 20 and/or to child IAB node 10C by DU 103 is establishment of a Radio Resource Control (RRC) channel, for example.

Control section 100 controls MT 102 and DU 103. Operation of IAB node 10 described below may be implemented by control section 100 controlling MT 102 and DU 103. Control section 100 may also be provided with a storage section for storing therein a variety of information.

<Study>

Parent IAB node 10A indicates the following time resources for a link with parent IAB node 10A (hereinafter, referred to as “parent link”) from a viewpoint of MT 102 of IAB node 10B:
DL time resource (time resource used for DL);
UL time resource (time resource used for UL); and
Flexible time resource (time resource used for DL or UL).

IAB node 10B, from a viewpoint of DU 103 of IAB node 10B, has the following types of time resources on a link between IAB node 10B and child IAB node 10C, and/or, on a link between IAB node 10B and UE 20 (these links are hereinafter referred to as “child link”):
DL time resource;
UL time resource;
Flexible time resource; and
Not-available time resource (a resource which is not used for communication on each of the child links of the DU).

Each of the DL, UL, and flexible time resources of the child link of the DU belongs to one of the following two classifications:
Hard: the time resource corresponding to this classification is always utilizable for the child link of the DU; and
Soft: the utilizability (hereinafter, also referred to as “availability”) of the time resource corresponding to this classification for the child link of the DU is controlled by parent IAB node 10A explicitly and/or implicitly.

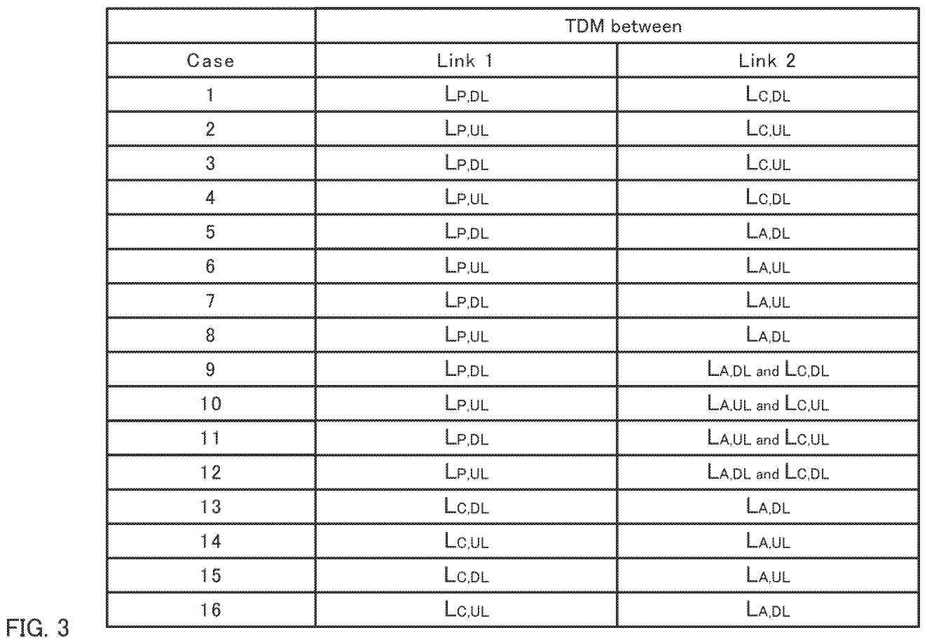

FIG. 3 illustrates cases of TDM supported by IAB nodes 10.

In FIG. 3, “Link 1” indicates the parent link and “Link 2” indicates the child link. For example, Case 1 in FIG. 3 indicates that the time division multiplexing between L_{P,DL} and L_{C,DL} is supported in one time resource for the TDM.

IAB nodes 10 are configured with time resources specific to those IAB nodes which are capable of utilizing links indicated at least by Cases 1 to 12 in FIG. 3.

In addition, Third Generation Partnership Project (3GPP) has been studying mechanisms for scheduling coordination, resource allocation, and route selection across the IAB nodes and the IAB donor, and multiple backhaul hops. 3GPP has also been studying supporting a semi-static configuration for communication signaling for the purpose of coordination of resources (in terms of frequency and slot or slot format, etc.) between IAB nodes 10.

The resource used from the viewpoint of MT is configured and controlled by parent IAB node 10A. The resource used from the viewpoint of DU is configured and controlled by IAB node 10B for child IAB node 10C and UE 20.

Considering operation in which downlink transmission timings are aligned between IAB nodes 10 in order to avoid influence on UE 20 in a Time Division Duplex (TDD) band, for example, the following are possible about the transmission/reception timing for IAB node 10B. That is, it is possible that IAB node 10B is unable to transmit a UL signal to parent IAB node 10A while transmitting a DL signal to UE 20 and/or child IAB node 10C. It is also possible that IAB node 10B is unable to receive a UL signal from UE 20 and/or child IAB node 10C while receiving a DL signal from parent IAB node 10A.

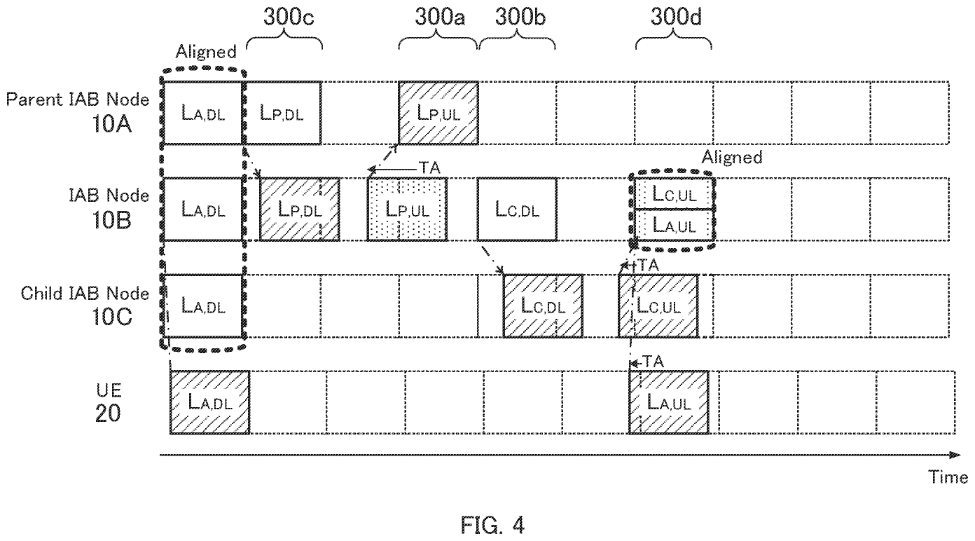

In this respect, a description will be given with reference to FIG. 4. FIG. 4 illustrates one example of the transmission/reception timings of signals transmitted or received between IAB nodes 10. In the following descriptions, the signal transmitted/received on the L_{P,DL} link, for example, may be referred to as “L_{P,DL} signal.” The same rule may apply to the signals transmitted/received on the other links.

Typically, the transmission timings (time resources for each period) of DL signals are aligned between IAB nodes 10. In addition, the transmission timing for IAB node 10B to transmit the UL signal to parent IAB node 10A is indicated from parent IAB node 10A to IAB node 10B. For example, the reception timing for parent IAB node 10A to receive the UL signal is controlled in accord with the transmission timing for parent IAB node 10A to transmit the DL signal. In that case, the transmission timing for IAB node 10B to transmit the UL signal is configured such that the reception timing for parent IAB node 10A to receive the UL signal is in accord with the transmission timing for parent IAB node 10A to transmit the DL signal.

As in the example of IAB node 10B described above, the transmission timing for child IAB node 10C to transmit the UL signal to IAB node 10B is indicated from IAB node 10B to IAB node 10C.

For example, in FIG. 4, transmission timing 300c for parent IAB node 10A to transmit the L_{P,DL} signal and reception timing 300a for parent IAB node 10A to receive the L_{P,UL} signal are aligned at a constant interval. Parent IAB node 10A notifies IAB node 10B of the transmission timing for the L_{P,UL} signal so as to receive the L_{P,UL} signal at reception timing 300a. IAB node 10B transmits the L_{P,UL} signal earlier by Timing Advance (TA) such that parent IAB node 10A is able to receive the L_{P,UL} signal at reception timing 300a. IAB node 10B also transmits the L_{C,DL} signal to child IAB node 10C at transmission timing 300b aligned for the DL signals between IAB nodes 10A, 10B, and 10C. “TA” is one example of information used for control of advancing the transmission timing for a signal, and may also be referred to by a name different from “TA.”

That is, the transmission timing for a certain IAB node 10 to transmit the UL signal corresponding to signal transmission toward the upstream side is configured in accord with the reception timing for upstream IAB node 10 to receive the UL signal. When the transmission timing for IAB node 10B to transmit the L_{C,DL} signal to the child IAB node and the transmission timing for IAB node 10B to transmit the L_{P,UL} signal to parent IAB node 10A are not configured (coordinated) separately, it is possible that IAB node 10B is unable to transmit the L_{P,UL} signal to parent IAB node 10A while transmitting the L_{C,DL} signal to child IAB node 10C. The same applies to transmission of the L_{A,DL} signal to UE 20.

In addition, in FIG. 4, the L_{P,DL} signal transmitted by parent IAB node 10A at transmission timing 300c is received by IAB node 10B later than transmission timing 300c due to a propagation delay, for example. Meanwhile, IAB node 10B receives, at transmission timing 300d, the L_{A,UL} signal and L_{C,UL} signal respectively transmitted by UE 20 and child IAB node 10C earlier than transmission timing 300d by the TA.

That is, a difference arises between, on the one hand, the reception timing for a certain IAB node to receive the DL signal corresponding to reception of a signal from the upstream side and, on the other hand, the transmission timing for the upstream IAB node to transmit the DL signal. Here, since IAB node 10B is unable to configure the reception timing for the L_{P,DL} signal from parent IAB node 10A and the reception timing for the L_{C,UL} signal from child IAB node 10C separately, it may be impossible to remove the difference. For this reason, it may be impossible to receive the L_{P,DL} signal from parent IAB node 10A while receiving the L_{C,UL} signal from child IAB node 10C. The same applies to the reception of the L_{A,UL} signal from UE 20.

Additionally, when IAB node 10B uses, for child IAB node 10C and/or UE 20, a part of the DL resources configured by IAB node 10A from the viewpoint of MT, IAB node 10B may fail to receive the DL signal from parent IAB node 10A.

Moreover, preparing configurations different between resources for the MT of child IAB node 10C and resources for UE 20 may result in complicated processing in IAB node 10B.

In view of the above, the present embodiment makes it simpler for IAB node 10B to configure resources for child IAB node 10C. In addition, the present embodiment clarifies how child IAB node 10C may use the resources, thereby preventing unintended operation of child IAB node 10C.

<Overview>

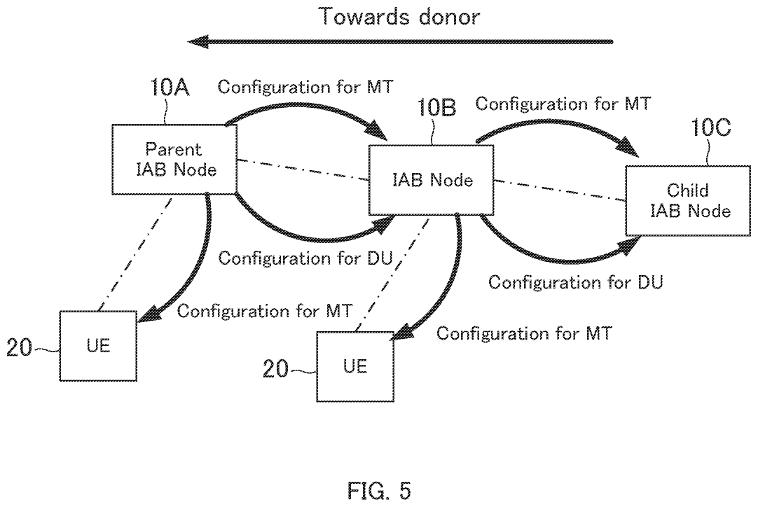

Next, the overview of the present embodiment is described with reference to FIG. 5.

As illustrated in FIG. 5, parent IAB node 10A provides IAB node 10B with separate configurations for MT and DU. Likewise, IAB node 10B provides child IAB node 10C with separate configurations for MT and DU. The same signaling (e.g., TDD-UL-DL-Config parameter) as in the configuration for a Rel-15 or Rel-16 UE may be used for the configuration for MT.

In addition, in IAB node 10B, the configuration for MT of child IAB node 10C may be at least partly the same as the configuration for MT of UE 20. For example, the configuration for MT of child IAB node 10C and the configuration for MT of UE 20 may be common to a cell-specific configuration.

The configuration for DU of child IAB node 10C by IAB node 10B may at least partly modify (overwrite) the configuration for MT of child IAB node 10C. Alternatively, the configuration for DU of child IAB node 10C by IAB node 10B may be provided so as not to be contradictory to the configuration for MT of child IAB node 10C.

That is, at least a part of the configuration for MT may be modified (or overwritten) according to the configuration for DU. In this case, the configuration for MT which is modified according to the configuration for DU may be provided for the DU. For example, with regard to resources notified as DL or Flexible by the TDD-UL-DL-Config parameter of the configuration for MT, IAB node 10B recognizes according to the configuration for DU that a part of the resources is available for child IAB node 10C and/or UE 20. In addition, with regard to resources notified as Physical Downlink Control Channel (PDCCH) Monitoring occasions by a search space configuration of the configuration for MT, IAB node 10B recognizes according to the configuration for DU that a part of the resources is available for child IAB node 10C and/or UE 20. IAB node 10B does not have to receive any DL signal from parent IAB node 10A on that part of the resources in these cases.

Alternatively, IAB node 10B may also assume that no contradiction arises between the configuration for MT and the configuration for DU with respect to at least the part of the resources.

Next, a description will be given of Examples 1 to 5 as examples related to the above overview. Two or more of Examples 1 to 5 may be combined together.

### Example 1: TDD Config

Next, a description will be given of an example of the configuration for MT and the configuration for DU related to a TDD Config parameter.

For the configuration for MT, each time resource is classified into any one of DL, UL, and Flexible. IAB node 10 may be notified of the TDD-UL-DL-Config parameter.

IAB node 10B may be notified, as the configuration for DU, of any one of the following pieces of information (DU resource information) (A1) to (A7) for at least a part of the time resources. The DU resource information may also be called “resource type.”

(A1) DL-hard: IAB node 10B may utilize, for the DL toward child IAB node 10C and/or UE 20 and independently of notification content of the configuration for MT, a resource for which the DU resource information of DL-hard is notified. That is, IAB node 10B may assume that the resource for which the DU resource information of DL-hard is notified is a resource which is not configured for reception of the DL signal from parent IAB node 10A or transmission of the UL signal to parent IAB node 10A.

(A2) DL-soft: As for a resource for which the DU resource information of DL-soft is notified, IAB node 10B may switch between the DL-hard assumption and a Not-available assumption according to an implicit or explicit indication separately provided from parent IAB node 10A. The implicit or explicit indication may be provided in addition to higher layer signaling, such as RRC signaling.

(A3) UL-hard: IAB node 10B may utilize, for the UL from child IAB node 10C and/or UE 20 and independently of the notification content of the configuration for MT, a resource for which the DU resource information of UL-hard is notified. That is, IAB node 10B may assume that the resource for which the DU resource information of UL-hard is notified is a resource which is not configured for reception of the DL signal from parent IAB node 10A or transmission of the UL signal to parent IAB node 10A.

(A4) UL-soft: As for a resource for which the DU resource information of UL-soft is notified, IAB node 10B may switch between the UL-hard assumption and the Not-Available assumption according to the implicit or explicit indication separately provided from parent IAB node 10A.

(A5) Flexible-hard: IAB node 10B may utilize, for the DL or UL toward or from child IAB node 10C and/or UE 20 and independently of the notification content of the configuration for MT, a resource for which the DU resource information of Flexible-hard is notified. That is, IAB node 10B may assume that the resource for which the Flexible-hard parameter is notified is a resource which is not configured for reception of the DL signal from parent IAB node 10A or transmission of the UL signal to parent IAB node 10A.

(A6) Flexible-soft: As for a resource for which the DU resource information of Flexible-soft is notified, IAB node 10B may switch between the Flexible-hard assumption and the Not-Available assumption according to the implicit or explicit indication separately provided from parent IAB node 10A.

(A7) Not-available: IAB node 10B may assume that a resource for which the DU resource information of Not-available is notified is a resource configured for reception of the DL signal from parent IAB node 10A or transmission of the UL signal to parent IAB node 10A according to the notification content of the configuration for MT. That is, IAB node 10B does not utilize, for child IAB node 10C and/or UE 20, the resource for which the DU resource information of Not-available is notified.

### Example 2: Common Search Space (CSS) Configuration

Next, a description will be given of an example of the configuration for MT and the configuration for DU related to a CSS.

IAB node 10B may be configured with a PDCCH-ConfigCommon parameter as the configuration for MT by parent IAB node 10A.

IAB node 10B may assume at least one of the following (B1) and (B2) when receiving, as the configuration for DU, the DU resource information of any one of the above (A1) to (A7) from parent IAB node 10A.

(B1) When resources configured as the PDCCH Monitoring occasions in the CSS for the configuration for MT are configured as DL-hard, UL-hard, or Flexible-hard for the configuration for DU, IAB node 10B does not have to perform PDCCH monitoring on the corresponding PDCCH Monitoring occasions in the CSS. Alternatively, when the resources configured as the PDCCH Monitoring occasions in the CSS for the configuration for MT are configured as DL-soft, UL-soft, or Flexible-soft for the configuration for DU, and it is separately indicated implicitly or explicitly that DL-soft, UL-soft, or Flexible-soft is assumed respectively as DL-hard, UL-hard, or Flexible-hard, IAB node 10B does not have to perform PDCCH monitoring on the corresponding PDCCH Monitoring occasions in the CSS.

(B2) IAB node 10B does not have to assume that at least a part of the resources configured as the PDCCH Monitoring occasions in the CSS for the configuration for MT is configured as DL-hard, UL-hard, or Flexible-hard for the configuration for DU. Alternatively, IAB node 10B does not have to assume that at least a part of the resources configured as the PDCCH Monitoring occasions in the CSS for the configuration for MT is configured as DL-soft, UL-soft, or Flexible-soft for the configuration for DU and it is separately indicated implicitly or explicitly that DL-soft, UL-soft, or Flexible-soft is assumed respectively as DL-hard, UL-hard, or Flexible-hard.

Assumptions the same as those for the aforementioned CSS search space configuration may be made also for a UE-specific search space configuration. Alternatively, assumptions at least partly different from those for the aforementioned CSS search space configuration may also be made for the UE-specific search space configuration. For example, one of the above (B1) and (B2) may be assumed for the CSS search space configuration and the other one of the above (B1) and (B2) for the UE-specific search space configuration.

### Example 3: Measurement Configuration

Next, a description will be given of an example of the configuration for MT and the configuration for DU related to a Measurement configuration.

IAB node 10B may be configured with a MeasObjectNR parameter, a RadioLinkMonitoringConfig parameter, and/or a BeamFailureRecoveryConfig parameter for the configuration for MT by parent IAB node 10A.

IAB node 10B may assume at least one of the following (C1) and (C2) when receiving, as the configuration for DU, the DU resource information of any one of the above (A1) to (A7) from parent IAB node 10A.

(C1) When resources configured for Measurement, RLM, BFD, and/or BFR as the configuration for MT are configured as DL-hard, UL-hard, or Flexible-hard for the configuration for DU, IAB node 10B does not have to perform detection, measurement operation, or PRACH transmission operation for BFR in the corresponding resources. Alternatively, when the resources configured for Measurement, RLM, BFD, and/or BFR as the configuration for MT are configured as DL-soft, UL-soft, or Flexible-soft for the configuration for DU, and it is separately indicated implicitly or explicitly that DL-soft, UL-soft, or Flexible-soft is assumed respectively as DL-hard, UL-hard, or Flexible-hard, IAB node 10B does not have to perform detection, measurement operation, or PRACH transmission operation for BFR in the corresponding resources. RLM is an abbreviation for Radio Link Monitoring. BFD is an abbreviation for Beam Failure Detection. BFR is an abbreviation for Beam Failure Recovery. PRACH is an abbreviation for Physical random access channel.

(C2) IAB node 10B does not have to assume that at least a part of the resources configured for Measurement, RLM, BFD, and/or BFR as the configuration for MT is configured as DL-hard, UL-hard, or Flexible-hard for the configuration for DU. Alternatively, IAB node 10B does not have to assume that at least a part of the resources configured for Measurement, RLM, BFD, and/or BFR as the configuration for MT is configured as DL-soft, UL-soft, or Flexible-soft for the configuration for DU and it is separately indicated implicitly or explicitly that DL-soft, UL-soft, or Flexible-soft is assumed respectively as DL-hard, UL-hard, or Flexible-hard.

The same assumption of the above (C1) or (C2) may be applied for (a) Radio Resource Management (RRM) measurement, (b) RLM, and (c) BFD and/or BFR. Alternatively, a different assumption may be applied for at least a part of the aforementioned (a) to (c). For example, one of the above assumptions (C1) and (C2) may be applied for one or two of the aforementioned (a) to (c), and the other one of the above assumptions (C1) and (C2) may be applied for the remaining one or two of the aforementioned (a) to (c).

### Example 4: RACH Configuration

Next, a description will be given of an example of the configuration for MT and the configuration for DU related to a RACH configuration. RACH is an abbreviation for Random Access Channel.

TAB node 10B may be configured with a PACH-ConfigGeneric parameter as the configuration for MT by parent TAB node 10A.

TAB node 10B may assume at least one of the following (D1) and (D2) when receiving, as the configuration for DU, the DU resource information of any one of the above (A1) to (A7) from parent TAB node 10A.

(D1) When resources configured for PRACH as the configuration for MT are configured as DL-hard, UL-hard, or Flexible-hard for the configuration for DU, TAB node 10B does not have to perform PRACH transmission operation in the corresponding resources. Alternatively, when the resources configured for the PRACH as the configuration for MT are configured as DL-soft, UL-soft, or Flexible-soft for the configuration for DU, and it is separately indicated implicitly or explicitly that DL-soft, UL-soft, or Flexible-soft is assumed respectively as DL-hard, UL-hard, or Flexible-hard, TAB node 10B does not have to perform the PRACH transmission operation in the corresponding resources.

(D2) TAB node 10B does not have to assume that at least a part of the resources configured for the PRACH as the configuration for MT is configured as DL-hard, UL-hard, or Flexible-hard for the configuration for DU. Alternatively, TAB node 10B does not have to assume that at least a part of the resources configured for PRACH as the configuration for MT is configured as DL-soft, UL-soft, or Flexible-soft for the configuration for DU and it is separately indicated implicitly or explicitly that DL-soft, UL-soft, or Flexible-soft is assumed respectively as DL-hard, UL-hard, or Flexible-hard.

The same assumption of the above (D1) or (D2) may be applied for Contention-based RACH and Contention-free RACH (including BFR). Alternatively, an at least partly different assumption may also be applied for Contention-based RACH and Contention-free RACH (including BFR). For example, one of the above assumptions (D1) and (D2) may be applied for Contention-based RACH and the other one of the assumptions (D1) and (D2) for Contention-free RACH.

### Example 5

As for at least a part of the operation of the above (A1) to (A7), (B1), (B2), (C1), (C2), (D1), and (D2), IAB node 10B may change the assumption and/or operation based on a configuration relevant to the transmission timing for IAB node 10B indicated by parent IAB node 10A. Next, (E1) and (E2) are illustrated as examples for this.

(E1) When a case where the UL transmission timing to parent IAB node 10A and the DL transmission timing to child IAB node 10C and/or UE 20 are united is indicated by parent IAB node 10A to IAB node 10B, even if a resource specified as UL or Flexible for the configuration for MT is indicated as DL-hard or DL-soft for the configuration for DU, IAB node 10B may follow both of the indications. That is, IAB node 10B may transmit the DL signal to child IAB node 10C and/or UE 20 while transmitting the UL signal to parent IAB node 10A.

(E2) When a case where the DL reception timing from parent IAB node 10A and the UL reception timing from child IAB node 10C and/or UE 20 are united is indicated by parent IAB node 10A to IAB node 10B, or when IAB node 10B applies the same operation even without such an indication, even if a resource indicated as DL or Flexible for the configuration for MT is indicated as DL-hard or DL-soft for the configuration for DU, IAB node 10B may follow both of the indications. That is, IAB node 10B may receive the UL signal from child IAB node 10C and/or UE 20 while receiving the DL signal from parent IAB node 10A.

When IAB node 10B applies the operation of the above (E2) without indication from parent IAB node 10A, IAB node 10B may report applying the operation of the above (E2) to parent IAB node 10A. Alternatively, when IAB node 10B does not apply the operation of the above (E2) without indication from parent IAB node 10A, IAB node 10B may report not applying the operation of the above (E2) to parent IAB node 10A. This makes it possible for parent IAB node 10A to understand how IAB node 10B operates.

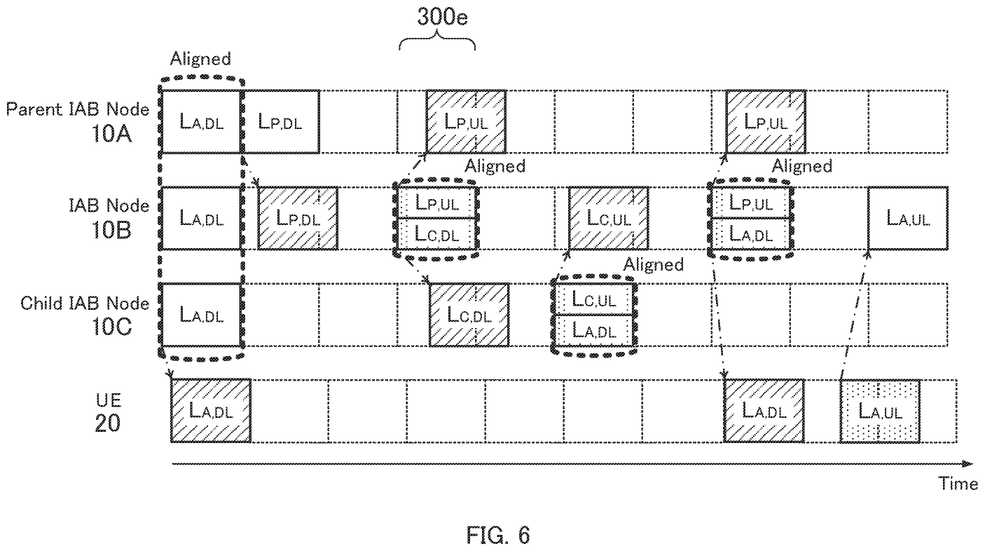

Next, the example of the above (E1) is described with reference to FIG. 6.

When the case of the above (E1) is indicated from parent IAB node 10A, IAB node 10B may transmit the L_{P,UL} signal to parent IAB node 10A and the L_{C,DL} signal to child IAB node 10C at transmission timing 300e. In this case, although parent IAB node 10A receives the L_{P,UL} signal later than transmission timing 300e, this is satisfactory since parent IAB node 10A recognizes that the L_{P,UL} signal is received with a delay.

Since IAB node 10B operates in accordance with both of the configuration for MT and the configuration for DU when the case of the above (E1) is indicated to IAB node 10B from parent IAB node 10A, it is possible to unite the transmission timing for the UL signal to parent IAB node 10A and the transmission timing for the DL signal to child IAB node 10C.

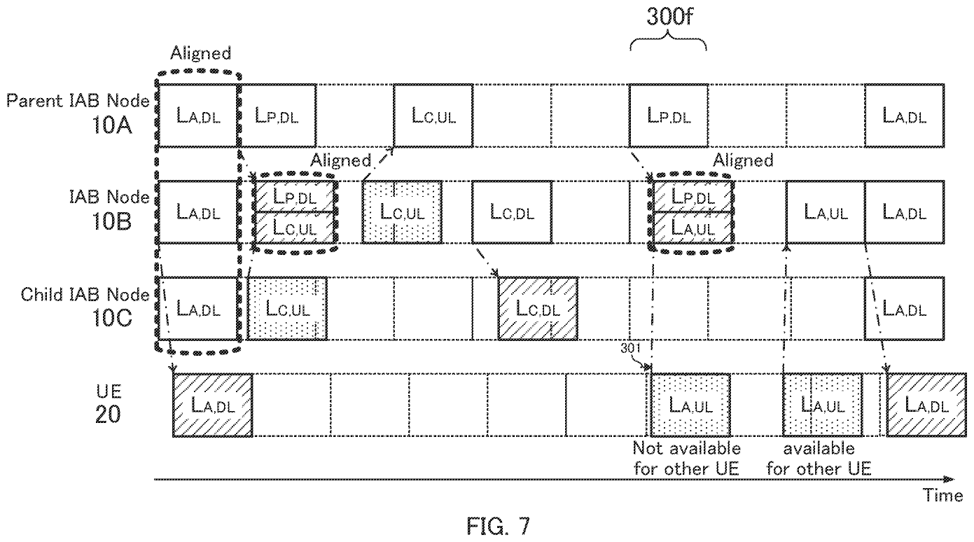

Next, the example of the above (E2) is described with reference to FIG. 7.

When the case of the above (E2) is indicated from parent IAB node 10A, IAB node 10B configures UE 20 with delay 301 in the transmission timing for the L_{A,UL} signal in consideration of a delay in the reception timing for the L_{P,DL} signal from parent IAB node 10A with respect to transmission timing 300f. This configuration for delay 301 in the transmission timing may be applied by IAB node 10B freely. This makes it possible for IAB node 10B to unite the reception timing for the L_{P,DL} signal from parent IAB node 10A and the reception timing for the L_{A,UL} signal from UE 20.

Since IAB node 10B operates in accordance with both of the configuration for MT and the configuration for DU when the case of the above (E2) is indicated to IAB node 10B from parent IAB node 10A, it is possible to unite the reception timing for the DL signal from parent IAB node 10A and the reception timing for the UL signal from child IAB node 10C.

When IAB node 10B unites the reception timing for the L_{P,DL} signal from parent IAB node 10A and the reception timing for the L_{A,UL} signal from UE 20, IAB node 10B may also configure at least one other UE with “Not-available” with respect to the transmission timing for the L_{A,UL} signal. When IAB node 10B does not unite the reception timing for the L_{P,DL} signal from parent IAB node 10A and the reception timing for the L_{A,UL} signal from UE 20, IAB node 10B may also configure at least one other UE with “available” with respect to the transmission timing for the L_{A,UL} signal.

<Modification>

It may be defined in the specifications that the DU of IAB node 10B may freely use the resource configured as Flexible for the configuration for MT. That is, it may be defined in the specifications that the reception of the DL signal from parent IAB node 10A and/or the transmission of the UL signal to parent IAB node 10A do not have to be assumed on the resource configured as Flexible for the configuration for MT.

Alternatively, IAB node 10B may determine the resource configured as Flexible for the configuration for MT to be “soft” and switch, according to the implicit or explicit indication from parent IAB node 10A, between a case where the resource may be used freely and a case where the resource may not be used freely.

Alternatively, it may be defined in the specifications that a resource, of the resources configured as Flexible for the configuration for MT, which is configured for specific use is prohibited from being freely used. The resource configured for specific use may be RRM measurement, the PDCCH Monitoring occasion, and/or the like. The resource prohibited from being freely used may also be assumed as a resource used for the reception of the DL signal from parent IAB node 10A or the transmission of the UL signal to parent IAB node 10A.

It may be possible to specify the granularity and/or the pattern of resources more flexibly for the configuration for DU than for the configuration for MT. For example, the notification of the DU resource information of any one of the above (A1) to (A7) may be given only with respect to a part of symbols (resources) while no notification is given with respect to the other symbols.

In addition, although the aforementioned (A1) to (A6) modify (overwrite) at least a part of the configuration for MT according to the configuration for DU, at least a part of the configuration for DU may also be modified (overwritten) according to the configuration for MT in the present embodiment. For example, it is possible to replace the configuration for MT and the configuration for DU described above with each other.

<Dynamic Indication of Availability for Soft Resource>

As stated above, the resource configurations for the child link of IAB node (e.g., DU) 10 include the hard and soft configurations for each of UL, DL, and flexible. The time resource configured as soft (hereinafter, referred to as “soft resource”) may be controlled by parent IAB node 10, for example.

Here, the availability pertinent to the soft resource may be configured or controlled not only statically or semi-statically, but also dynamically. For example, the availability of the soft resource may be dynamically indicated to child IAB node 10 from parent IAB node 10 using the signaling of Layer 1 (L1 signaling). For implementing the dynamic indication (which may also be referred to as “notification”) of the availability pertinent to the soft resource, there is room for study on the details of matters such as signaling mechanisms, potential enhancements, and restrictions on processing time for IAB node 10.

If methods of making available and non-available the soft resource and/or relevant operation of IAB nodes 10 are not clarified, it is possible that communication between IAB nodes 10 and/or between IAB node 10 and UE 20 is not performed appropriately, so that the communication may be ended.

It is thinkable, for example, to define new signaling for the dynamic indication of the availability pertinent to the soft resource; however, it is possible that the new signaling causes definitions in the specifications or standard to be complicated. There is also a possibility that the configuration and/or processing of IAB nodes 10 or UE 20 may, for example, be complicated, since signals to be detected by IAB nodes 10 or UE 20 increase.

In this respect, a description will be given of a technique of making it possible to dynamically notify child IAB node 10 or UE 20 of the availability of the soft resource by utilizing the existing signaling, for example. This dynamic notification may be referred in short to “soft-configuration dynamic notification,” for convenience.

According to the soft-configuration dynamic notification in the present disclosure, it is possible to achieve effective use of the resources for the wireless backhaul link and/or the wireless access link while reducing impact on the definitions in the specifications or standard, and/or on implementation.

For example, when IAB node 10 is provided with DL or UL scheduling by parent IAB node 10 for a resource configured as soft, in other words, when IAB node 10 receives the DL or UL scheduling information from parent IAB node 10 for the resource configured as soft, the soft resource may be interpreted (or assumed, determined, or decided (the same rewording applies below)) as being configured as or changed to “not available” from the viewpoint of DU.

Additionally or alternatively, when parent IAB node 10 indicates, to IAB node 10, a slot format indication (SFI) for the resource configured as soft, in other words, when IAB node 10 receives the SFI for the resource configured as soft, the resource configured as “flexible (F)” may be interpreted as being configured as or changed to “available.” Child IAB node 10 may be notified of the SFI using the higher layer signaling (e.g., UE-group common signalling). For example, the SFI may be included in a group common-PDCCH.

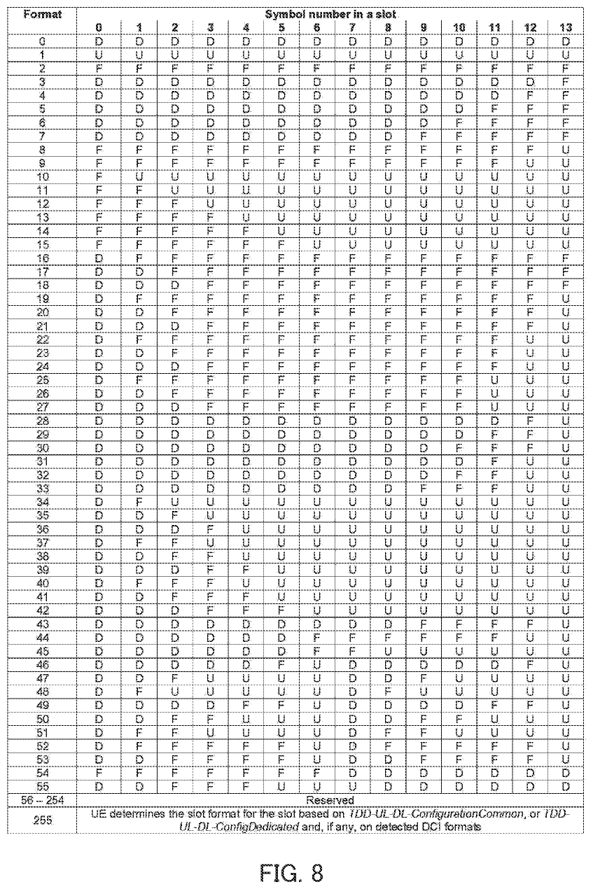

Additionally or alternatively, formats to which “A” indicating “available” (or “N” indicating “not available”) is added in addition to “D” (DL), “U” (UL), and “F” (flexible) may be defined for code points indicated as Reserved in existing SFI code points (or, format identification information). One example of the SFI is illustrated in FIG. 8. FIG. 8 is shown in NPL 3 as Table 11.1.1-1, for example.

FIG. 8 illustrates an example in which one of “D,” “U,” and “F” is specified for each symbol of code points 0 to 255. Code points 56 to 254 among code points 0 to 255 are Reserved in FIG. 8. Therefore, a format in which “D,” “U,” “F,” or “A” (and/or “N”) is specified for each symbol of some or all of code points 56 to 254 may be defined.

The content of the SFI illustrated in FIG. 8 is one example of notification information of the existing signaling, and the information content of the existing signaling is not limited to the example of FIG. 8. The information such as “A” or “N” explicitly or implicitly indicating that a resource is available or not available (the information may be positioned in “control information”) only has to be associated with a specific resource in the slot format of a signal received by IAB node 10. IAB node 10 is able to dynamically control the resource configurations for the child link based on this information.

For example, IAB node 10 may interpret that the resource (e.g., symbol) specified as “A” (or “N”) is configured as or changed to “available” from the viewpoint of DU. Alternatively, IAB node 10 may also interpret that the resource (e.g., symbol) specified as “N” (or “A”) is configured as or changed to “not available” from the viewpoint of DU.

IAB node 10 performs control (e.g., resource allocation control) according to (or based on) the above interpretations.

As understood from the above descriptions, according to the soft-configuration dynamic notification of the present disclosure, the resource configurations for the child link of IAB node 10 are dynamically controllable by parent IAB node 10 by the indication utilizing the existing signaling without defining new signaling.

Accordingly, it is possible to achieve effective use of the resources for the wireless backhaul link and/or the wireless access link while reducing impact on the definitions in the specifications or standard, and/or on implementation.

The soft-configuration dynamic notification described above may also be applied to a resource configured as hard. The soft-configuration dynamic notification and the resource configurations based on this notification may also be applied on a symbol-by-symbol basis or on the basis of a group of a plurality of symbols. The soft-configuration dynamic notification may also be combined for implementation with the various kinds of examples described in the embodiments including the modifications stated above.

### Conclusion of Present Disclosure

The wireless node according to the present disclosure includes: a reception section that receives first configuration information on a first wireless backhaul link, and second configuration information on at least one of a second wireless backhaul link and a wireless access link; and a control section that controls a first resource configuration for the first wireless backhaul link, and a second resource configuration for at least one of the second wireless backhaul link and the wireless access link based on the first configuration information and the second configuration information.

Here, the first wireless backhaul link may, for example, be the DL and/or UL between parent IAB node 10A and IAB node 10B. The second wireless backhaul may, for example, be the DL and/or UL between IAB node 10B and child IAB node 10C. The wireless access link may, for example, be the DL and/or UL between IAB node 10B and UE 20. The first configuration information may, for example, be the configuration for MT. The second configuration information may be the configuration for DU. The first resource configuration may, for example, be the configuration in MT 102. The second resource configuration may, for example, be the configuration in DU 103.

As described above, the first configuration information (configuration for MT) and the second configuration information (configuration for DU) are separate from each other, so that it is possible for the wireless node (IAB node 10B) to appropriately apply the resource configuration for the wireless link with the upstream wireless node (parent IAB node 10A) and the resource configuration for the wireless link with the downstream wireless node (child IAB node 10C) and/or UE 20.

In addition, the control section may also control the second resource configuration based on information that is the first configuration information at least partly modified according to the second configuration information.

At least partly modifying the first configuration information according to the second configuration information thus allows reduction in the amount of information of the second configuration information.

The present disclosure has been described above.

<Hardware Configuration and/or the Like>

Note that, the block diagrams used to describe the above embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or wirelessly), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit” or “transmitter.” The methods for implementing the functions are not limited specifically as described above.

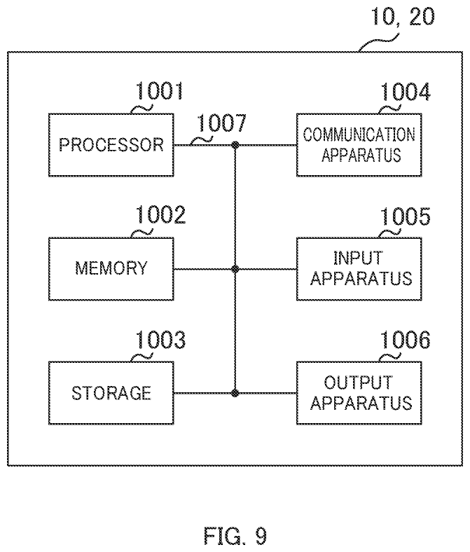

For example, the base station, user equipment, and the like according to an embodiment of the present disclosure may function as a computer that executes processing of a wireless communication method of the present disclosure. FIG. 9 illustrates one example of a hardware configuration of an IAB node and a user equipment according to one embodiment of the present disclosure. IAB node 10 and user equipment 20 described above may be physically constituted as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of IAB node 10 and of user equipment 20 may include one apparatus or a plurality of apparatuses illustrated in the drawings or may not include part of the apparatuses.

The functions of IAB node 10 and user equipment 20 are implemented by predetermined software (program) loaded into hardware, such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 100 and the like as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control section 100 of IAB node 10 may be implemented by a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented by one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the method according to the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blue-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and wireless networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, antennas and the like of the base station and the user equipment may be realized by communication device 1004. A transmission/reception section may be implemented with a transmission section and a reception section physically or logically separated from each other.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which makes outputs to the outside. Note that input apparatus 1005 and output apparatus 1006 may be integrated (for example, a touch panel).

The apparatuses, such as processor 1001, memory 1002, and the like are connected by bus 1007 for communication of information. Bus 1007 may be configured using a single bus or using buses different between each pair of the apparatuses.

Furthermore, IAB node 10 and user equipment 20 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

<Notification and Signaling of Information>

The notification of information is not limited to the aspects or embodiments described in the present disclosure, and the information may be notified by another method. For example, the notification of information may be carried out by one or a combination of physical layer signaling (for example, Downlink Control Information (DCI) and Uplink Control Information (UCI)), upper layer signaling (for example, Radio Resource Control (RRC) signaling, Medium Access Control (MAC) signaling, notification information (Master Information Block (MIB), and System Information Block (SIB))), and other signals. The RRC signaling may be called an RRC message and may be, for example, an RRC connection setup message, an RRC connection reconfiguration message, or the like.

<Applied System>

The aspects and embodiments described in the present specification may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

<Processing Procedure and the Like>

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

<Operation of Base Station>

Specific operations which are described in the present disclosure as being performed by the base station may sometimes be performed by an upper node depending on the situation. Various operations performed for communication with a user equipment in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (for example, MME and S-GW).

<Direction of Input and Output>

The information or the like (see the item of “Information and Signals”) can be output from a higher layer (or a lower layer) to a lower layer (or a higher layer). The information, the signals, and the like may be input and output through a plurality of network nodes.

<Handling of Input and Output Information and the Like>

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

<Determination Method>

The determination may be made based on a value expressed by one bit (0 or 1), based on a Boolean value (true or false), or based on comparison with a numerical value (for example, comparison with a predetermined value).

<Variations and the Like of Aspects>

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

<Software>

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

<Information and Signals>

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

<“System” and “Network”>

The terms “system” and “network” used in the present disclosure can be interchangeably used.

<Names of Parameters and Channels>

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (for example, PUCCH and PDCCH) and information elements, can be identified by any suitable names, and various names assigned to these various channels and information elements are not limitative in any respect.

<Base Station>

The terms “Base Station (BS),” “wireless base station,” “fixed station,” “NodeB,” “eNodeB (eNB),” “gNodeB (gNB),” “access point,” “transmission point,” “reception point, “transmission/reception point,” “cell,” “sector,” “cell group,” “carrier,” and “component carrier” may be used interchangeably in the present disclosure. The base station may be called a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

<Mobile Station>

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

<Base Station/Mobile Station>

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user equipment. For example, the aspects and the embodiments of the present disclosure may find application in a configuration that results from replacing communication between the base station and the user equipment with communication between multiple user equipments (such communication may, e.g., be referred to as device-to-device (D2D), vehicle-to-everything (V2X), or the like). In this case, user equipment 20 may be configured to have the functions that base station 10 described above has. The wordings “uplink” and “downlink” may be replaced with a corresponding wording for inter-equipment communication (for example, “side”). For example, an uplink channel, a downlink channel, and the like may be replaced with a side channel.

Similarly, the user equipment in the present disclosure may be replaced with the base station. In this case, base station 10 is configured to have the functions that user equipment 20 described above has.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry)(e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like hat are non-limiting and non-inclusive examples.

<Reference Signal>

The reference signal can also be abbreviated as an RS and may also be called as a pilot depending on the applied standard.

<Meaning of “Based On”>

The description “based on” used in the present disclosure does not mean “based only on,” unless otherwise specified. In other words, the description “based on” means both of “based only on” and “based at least on.”

<Terms “First” and “Second”>

Any reference to elements by using the terms “first,” “second,” and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

<“Means”>

The “means” in the configuration of each apparatus described above may be replaced with “section,” “circuit,” “device,” or the like.

<Open-Ended Format>

In a case where terms “include,” “including,” and their modifications are used in the present disclosure, these terms are intended to be inclusive like the term “comprising.” Further, the term “or” used in the present disclosure is not intended to be an exclusive or.

<Time Units Such as a TTI, Frequency Units Such as an RB, and a Radio Frame Configuration>

The radio frame may be constituted by one frame or a plurality of frames in the time domain.

The one frame or each of the plurality of frames may be called a subframe in the time domain.

The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in wireless communication. For example, in an LTE system, the base station performs scheduling for allocating a radio resource (a frequency bandwidth, a transmit power, and the like that are used in each user equipment) on the basis of TTI to each user equipment. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

<Maximum Transmit Power>

The “maximum transmit power” described in the present disclosure may mean a maximum value of the transmit power, the nominal UE maximum transmit power, or the rated UE maximum transmit power.

<Article>

In a case where articles, such as “a,” “an,” and “the” in English, for example, are added in the present disclosure by translation, nouns following these articles may have the same meaning as used in the plural.

<“Different”>

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

The present patent application claims the benefit of priority based on Japanese Patent Application No. 2018-214633 filed on Nov. 15, 2018, and the entire content of Japanese Patent Application No. 2018-214633 is hereby incorporated by reference.

### INDUSTRIAL APPLICABILITY

One aspect of the present disclosure is useful for wireless communication systems.

### REFERENCE SIGNS LIST

10, 10A, 10B, 10C IAB node
20 UE
100 Control section
102 MT (Mobile Termination)
103 DU (Distributed Unit)

1. A wireless node, comprising:
a reception section that receives first information on availability of a resource of at least one of a wireless backhaul link and a wireless access link; and
a control section that, when the reception section receives second information on a configuration of the resource, controls the availability of the resource based on the second information.

2. The wireless node according to claim 1, wherein
the first information indicates that the availability of the resource is controlled by another wireless node,
the second information is scheduling information for the resource, and
the control section determines by receipt of the scheduling information that the resource is configured as not available.

3. The wireless node according to claim 1, wherein
the first information indicates that the availability of the resource is controlled by another wireless node,
the second information is format information indicating the availability of the resource for each unit time, and
the control section determines by receipt of the format information that the resource whose availability is specified as flexible in the first information is configured as available.

4. A resource control method, comprising steps performed by a wireless node of:
receiving first information on availability of a resource of at least one of a wireless backhaul link and a wireless access link; and
controlling, when the reception section receives second information on a configuration of the resource, the availability of the resource based on the second information.
